(19) United States
(12) Patent Application Publication
(10) Pub. No.: US 2007/0239861 A1
(43) Pub. Date: Oct. 11, 2007

(54) System and method for automated operating system installation

(75) Inventors: Drue Reeves, Round Rock, TX (US); Brent Schroeder, Austin, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/398,054

(22) Filed: Apr. 5, 2006

(51) Int. Cl. G06F 15/177

(52) U.S. Cl. 709/222; 709/220

(57) ABSTRACT

A system and method for automatically installing an operating system from a deployment server to a target server utilizing a directory service. The directory service utilizes target objects and policy objects to authenticate the identity of a particular target and then to direct the target system to a deployment server that maintains a validated image of a desired operating system. The target system then communicates with the deployment server in order to install the appropriate operating system.

### TECHNICAL FIELD

The present invention is related to the field of computer systems and more specifically to an automated system and method for installing operating systems.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Operating Systems are used by computing systems and other information handling system components to manage the applications run by the computing systems. The installation of operating systems onto an information handling system component often requires significant time and resources. Additionally, Information Technology organization and system administrators must ensure that operating systems are properly licensed, contain only approved and validated code and are loaded onto the appropriate computing systems. The determination and management of this information requires significant time, effort and resources, typically requiring system administers to manually gather and manage this information. Failure to ensure that operating systems are properly licensed and installed will likely lead to significant problems and expense.

### SUMMARY OF THE INVENTION

Therefore a need has arisen for an improved system and method for installing operating systems within computers.

A further need has arisen for authenticating target systems and installing validated operating systems onto target systems.

The present disclosure describes a system and method utilizing a directory service for automating the installation of operating systems onto target computers. The directory service utilizes target objects and policy objects to authenticate the identity of a particular target and then to direct the target system to a deployment server that maintains a validated image of a desired operating system. The target system then communicates with the deployment server in order to install the selected operating system.

In one aspect an information handling system is disclosed including one or more target systems in communication with a directory service where the target system includes a LDAP client stack. The directory service has one or more target objects and one or more operating system policy objects. The directory service is able to authenticate the target system and direct the target system to a deployment server for operating system installation. The deployment server is in communication with the target system in the directory service. The deployment server includes at least one operating system image for installation onto the target system.

In another aspect, a directory system for operating installation is disclosed. The directory system includes multiple target objects and multiple policy objects. Each target object is associated with a target system and includes a user name and a password for authenticating the target system. Each of the policy objects is associated with one or more of the target objects. And each policy object indicates the location for providing a selected operating system image for installation onto a target system.

In yet another aspect, a method for installing an operating system is described including first booting a target system to a LDAP client stack and then communicating a target system authentication string to a directory service. Next, the target system is authenticated using a target object and then accessing a policy object that is associated with a target object after completion of the authentication step. Next, the method includes obtaining instructions from the policy object that direct the target system to access a deployment server for obtaining a validated operating system.

The present disclosure provides a number of important technical advantages. One important technical advantage is the use of target objects and policy objects within a directory service for use in installing an operating system. The use of the directory service allows for centralized management and updating of policy information and target system information. This also provides a improved method for ensuring that all target systems are properly identified and that only validated operating system code is installed onto target systems. Additional advantages will be apparent to those of skill in the art and from the figures, description and claims provided herein.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 shows an information handling system for the automated installation of an operating system according to teachings of the present disclosure;

FIG. 2 shows an expanded system for automated installation of operating systems onto a target server; and

FIG. 3 shows an automated method for installing an operating system onto a target server.

### DETAILED DESCRIPTION OF THE INVENTION

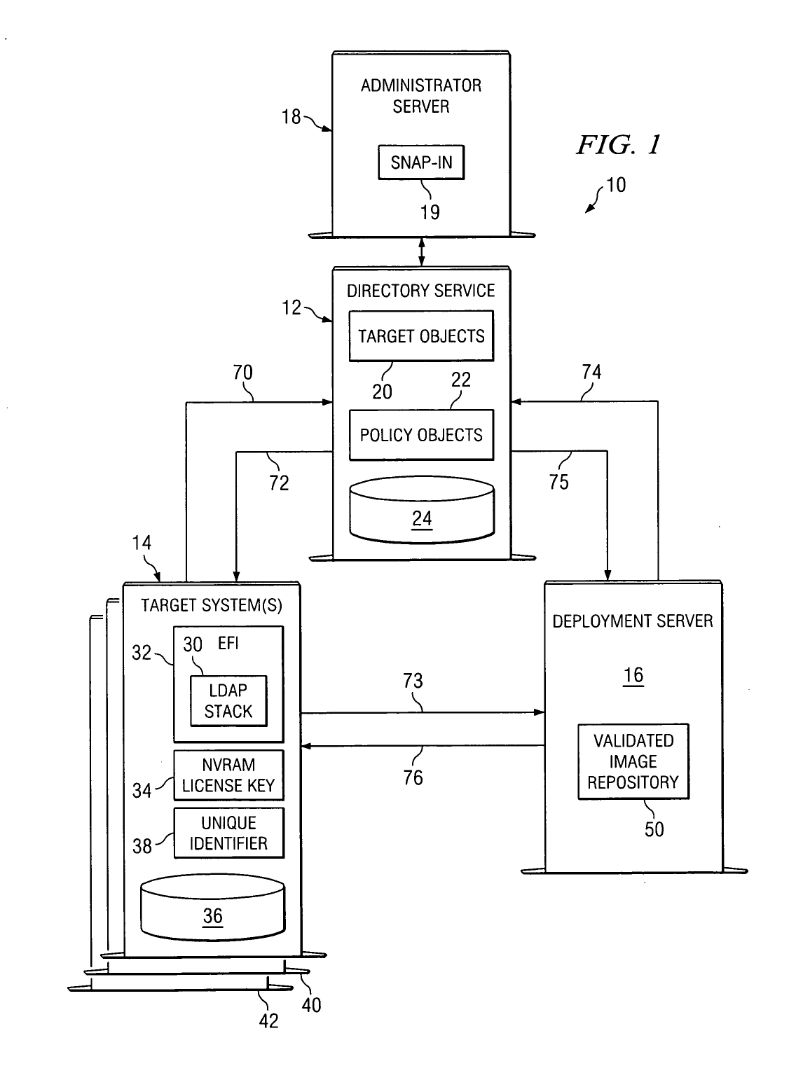

Preferred embodiments of the invention and its advantages are best understood by reference to FIGS. 1-3 wherein like numbers refer to like and corresponding parts and like element names to like and corresponding elements.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Now referring to FIG. 1, an information handling system indicated generally at 10 is shown. Information Handling System 10 includes directory service 12 in communication with target system 14 and deployment server 16. Directory service 12 is also in communication with administrative server 18. Directory service 12 generally includes target objects 20 and policy objects 22. Directory service 12 also includes memory resource 24. In a preferred embodiment memory resource 24 may store authentication policies 20 and 22.

In the present embodiment, directory service 12 is in communication with target system 14 as well as additional target systems 40 and 42. Target system 24 shall be discussed in greater detail herein, however, it should be understood that additional target systems 40 and 42 may include similar elements, functionality and controlling logic. Target system 14 includes lightweight directory access protocol (LDAP) client stack 30, EFI 32 and license key 34. Deployment server 16 includes validated image repository 50.

In operation, administrative server 18 allows an administrator to create and/or modify target server objects 20 and policy objects 22 within directory service 12. Administrative server 18 also preferably allows an administrator to associate each individual policy object 22 with one or more target objects 20. In a preferred embodiment a so-called snap-in utility 19 may be used to create a target object. Snap-in utility 19 may comprise a module of code that may be incorporated with a larger framework in order to provide the functionality described herein. Snap-in module 19 may include executable instructions for managing target objects 20 and policy objects 22 within directory service 12. In one example embodiment, snap-in module 19 may be incorporated within a Microsoft management Console (MMC) In alternate embodiments any suitable utility may be provided by administrative server 18 to construct and modify target objects and/or policy objects.

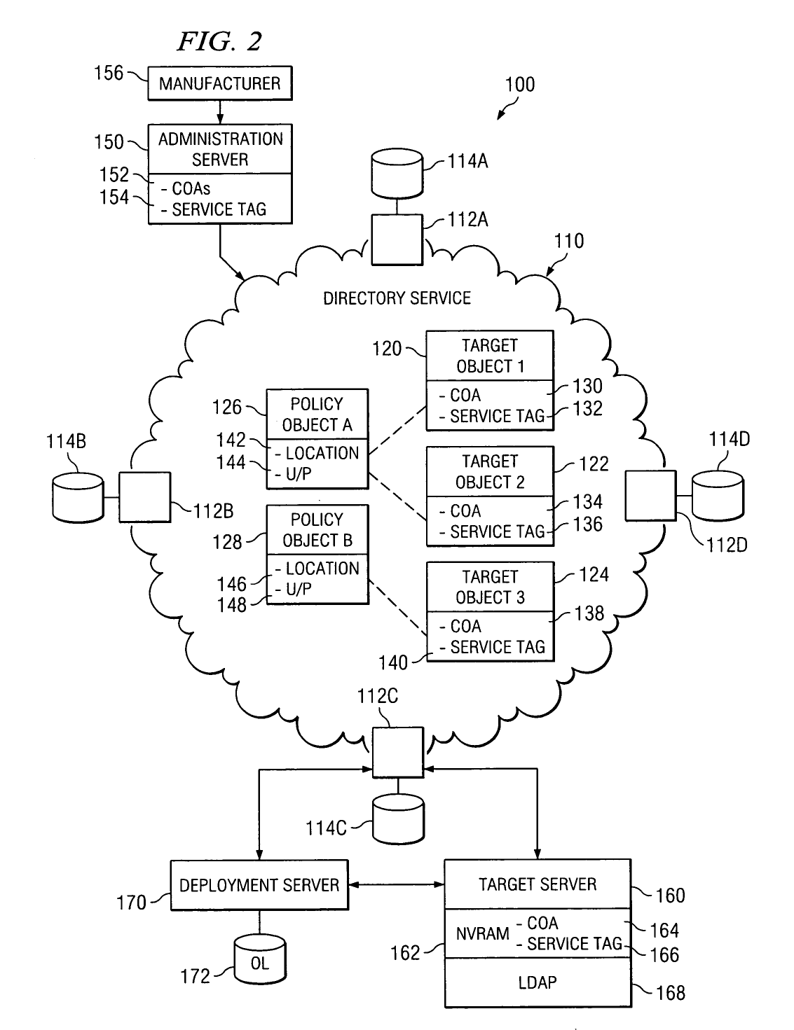

Target objects 20, which may also be referred to herein as a target server objects, are objects that are each associated with a particular target system (such as target system 12). Each target object includes a username and a password (as described below with respect to FIG. 2). In the present embodiment the username is a unique identifier 38 associated with target system 14. In a preferred embodiment, unique identifier 38 comprises a service tag number or similar identifier provided by the manufacturer of target system 14.

In a preferred embodiment, the password for a target object 20 associated with target system 14 is license key 34 that has been assigned to target system 14. This ensures that the target system 14 can be authenticated and also ensures that target system 14 has properly licensed to load a particular operating system thereon. License key 34 may also be referred to as a notice of authenticity (NOA). In an alternative embodiment, target system 14 and target object 20 may utilize any suitable password scheme.

Deployment server 16 includes utilities for communicating with target system 14 and directory service 12. Deployment server 16 includes one or more operating systems stored within image repository 50. In the present preferred embodiment, all of the operating system images stored within repository 50 have been validated.

In operation, target server 12 first boots to LDAP client stack 30 of EFI 32. Target server 14 then authenticates to directory service 12 using service tag 38 as its username and license key 34 for a password (arrow 70). During this step directory service 12 searches for a target object having the same username and verifies that the password is correct. Next, directory service 12 then identifies a policy object associated with the selected target object 20. The policy object preferably includes instructions for operating system installation instructions which are sent to target system 12 (arrow 72). These instructions may provide the location of deployment server 16 and may also include an authentication string to be provided to deployment server 16.

After receiving the installation instructions target server 14 may then submit a request to deployment server 16 to carry out the automated installation of a selected operating system (arrow 73). In a preferred embodiment, target system requests a Preboot execution (PXE) boot from deployment server 16 and may preferably send the authentication string to deployment server 16.

Deployment server 16 then authenticates to the directory service 12 to match the authorization string of the target server 14 with the policy that is associated with the target server object and determines the appropriate operating system to deploy. In an alternate embodiment, deployment server 16 may commence operating system installation without validating the authorization string—for instance, deployment server 16 may store authorization codes. An image of the appropriate operating system image is then provided to target system 14 (arrow 76) and target server 14 may then initiate operating system deployment. Target server 14 may then complete operating system installation and activation using its license key 34.

Now referring to FIG. 2 information handling system 100 is shown. Information handling system 100 generally includes target server 160, deployment server 170 and administrative server 150 all in communication with directory service 110. Directory service 110 includes servers 112A, 112B, 112C and 112D. Each server 112 includes a corresponding memory resource 114. Each server 112 may preferably be located in a separate location and provide local access to the directory service. In this manner, directory service 110 may locate servers 112 at different locations within a single facility or in different states or continents. Servers 112 preferably communicate using methods and protocols well known to those of skill in the art to communicate informational updates such that all of the servers 112A-D each contains the same pertinent information and that information that is introduced to one servers is updated within the other servers within directory service 110.

In the present embodiment, directory service 110 includes target objects 120, 122 and 124 and policy objects 126 and 128. Target object 1-120 includes a username (service tag 132) and a password (COA 130). Target object 2-122 includes a username (service tag 136) and a password (COA 134). Target object 3-124 includes a username (service tag 140) and a password (COA 138). Policy object A-126 includes location information 142 and U/P field 144. Similarly, policy object B-128 includes location information 146 and U/P field 148. U/P field 148 may include username and password information for authenticating to deployment server 170. In alternate embodiments, more or fewer target objects and/or policy objects may be provided within directory service 110.

In the present embodiment policy object A-126 is associated with target object 1-120 and target object 2-122. Policy object B-128 is associated with target object 3-124. In this manner policy object A-126 may be used to direct the operating system installation for a target system associated with either target object 1-120 or target object 2-122. Additionally, policy object B-128 will be used to direct operating installation for a target system identified by target object 3. In alternate embodiments policy objects 126 and 128 may be associated with more or fewer target objects.

Administrative server 150 may store a plurality of data sets of COAs 152 and service tags 154. This information may preferably be used to populate, modify and evaluate target objects and policy objects managed by administration server 150. Administration server 156 may receive information from manufacturer 156, thereby allowing administration server 150 to obtain information related to target systems, such as unique identifiers and COAs.

Target server 160 is in operative communication with server C-112. Target server 160 includes a persistent memory 162 storing COA 164 and unique identifier 166. In the present embodiment, a so-called service tag is provided unique identifier, however, in alternate embodiments any suitable identifier may be used. Target server 160 preferably includes LDAP client stack 168 for allowing target server 160 to perform a limited boot to allow it to communicate with directory service 110 and deployment server 170 in order to obtain an operating system.

Deployment server 170 is in communication with target server 160 and with server 112C. Deployment server includes memory resource 172 which is operable to store one or more images of operating system for installation onto target server 160 or other target servers.

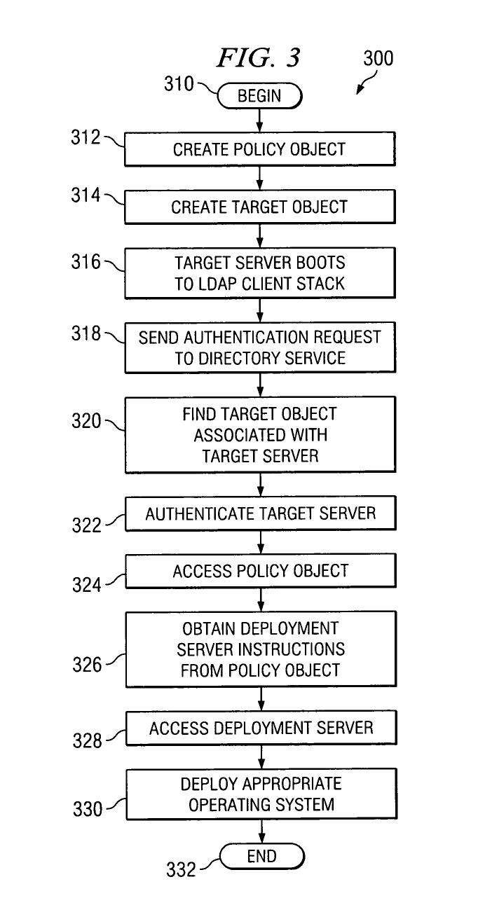

Now referring to FIG. 3, a method indicated generally at 300 is shown. Method begins 310 by first creating one or more policy objects 312 and one or more target objects 314. The policy objects and target objects are then loaded on a directory service that is made available to target servers. A target server may then boot to an LDAP client stack 316 stored thereon and send an authentication request to directory service 318. The target object associated with the target server is then retrieved in order to authenticate target server 322 using a user name and a password. In a preferred embodiments the user name may comprise a unique identifier for identifying the target system and the password may be a license assigned to the target system. Following authentication, the policy object associated with the pertinent target object is accessed 324 in order to obtain deployment server instructions from policy object 326. These instruction preferably identify the operating system that is to be deployed onto the target server. This step may also include providing the target server with an authentication string used to allow the deployment server to authenticate the operating system deployment request.

Target system 14 then preferably accesses deployment server 328 to request the deployment of an operating system. As described above, accessing component server may also include providing deployment server with an authentication string provided by the policy object. In some embodiments the deployment server may validate the authentication string with the directory service. In other embodiments, deployment server may validate the authentication string without having to contact the directory service. Next the appropriate operating system is deployed onto the target system 330. This method ends following installation of the correct operating system onto target system 14.

Although the disclosed embodiments have been described in detail, it should be understood that various changes, substitutions and alterations can be made to the embodiments without departing from their spirit and scope.

What is claimed is:

1. An information handling system comprising:
at least one target system communicatively coupled with a directory service, said target system having a LDAP client stack;
the directory service having at least one target object and at least one operating system policy object, the directory service operable to authenticate the at least one target system and direct the at least one target system to a deployment server for operating system installation; and
the deployment server in communication with the at least one target system and the directory service, the deployment server having at least one operating system image stored thereon.

2. The information handling system of claim 1 wherein the target system comprises at least one unique identifier operable to identify the target system.

3. The information handling system of claim 2 wherein the at least one unique identifier comprises a service tag associated with the target system.

4. The information handling system of claim 1 wherein the target system comprises a license key associated with the target system.

5. The information handling system of claim 4 wherein the license key comprises a certificate of authenticity (COA).

6. The information handling system of claim 1 wherein the target system further comprises a persistent memory, the LDAP client stack stored on the persistent memory.

7. The information handling system of claim 6 wherein the persistent memory comprises a non-volatile RAM.

8. The information handling system of claim 1 wherein:
the deployment server comprises a plurality of operating system images; and
the directory service comprises a plurality of operating system authentication policies, each authentication policy operable to direct at least one selected target system to the deployment server for installing a selected operating system.

9. The information handling system of claim 1 further comprising an administrative server in communication with the directory service, the administrative server operable to manage the at least one operating system policy object and the at least one target object.

10. The information handling system of claim 9 further comprising a plurality of target systems associated with the directory service.

11. The information handling system of claim 10 comprising:
a plurality of target objects each comprising a username and an associated password, each target object associated with a target system and operable to authenticate the associated target system.

12. The information handling system of claim 1 wherein the target server is operable to boot to the LDAP client stack and subsequently communicate an authentication string to the directory service.

13. The information handling system of claim 1 wherein the at least one target system comprising an interface operable to run the LDAP client stack in a pre-boot environment.

14. A directory system for operating system installation comprising:
a plurality of target objects, each target object associated with a target server and comprising a username and a password for authenticating a target system; and
a plurality of policy objects, each policy object associated with one or more target objects, each policy object indicating a location providing an appropriate operating system image for installing onto a target system.

15. The directory system of claim 14 wherein each username comprises a unique identifier associated with a target server.

16. The directory system of claim 15 wherein each password comprises a license key associated with the target server.

17. The directory system of claim 15 comprising a plurality of directory service servers each maintaining the plurality of target objects and the plurality of policy objects thereon.

18. A method for installing an operating system comprising:
booting a target system to a LDAP client stack;
communicating a target system authentication string to a directory service;
authenticating the target system using a target object;
accessing a policy object associated with the target object after authenticating the target; and
obtaining operating system installation instructions from the policy object, the installation instructions directing the target system to access a deployment server having an operating system image store thereon.

19. The method of claim 18 wherein the authentication string comprises a username and a password.

20. The method of claim 19 wherein the user name comprises a unique identifier operable to identify the target system and the password comprises a license tag assigned to the target system.
